(19) United States
(12) Patent Application Publication
(10) Pub. No.: US 2026/0296488 A1
(43) Pub. Date: Oct. 1, 2026

(54) TRAVELING ASSISTANCE APPARATUS

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Soichi TANIGUCHI, Tokyo (JP); Daiki MARUKI, Nagakute-shi (JP); Takuya NAKAGAWA, Okazaki-shi (JP); Riku HAMABE, Toyota-shi (JP)

(21) Appl. No.: 19/576,481

(22) Filed: Mar. 24, 2026

(30) Foreign Application Priority Data
Mar. 27, 2025 (JP) 2025-053845

(51) Int. Cl. B60W 60/00; G01S 19/01; G06V 20/58

(52) U.S. Cl. CPC B60W 60/001; G01S 19/01; G06V 20/58

(57) ABSTRACT

A traveling assistance apparatus includes: a registration unit generating registration information related to a registration route from a start point to a destination point; and a traveling control unit performing a traveling assistance control using the registration information to cause a vehicle to travel to the destination point when a start condition where the vehicle approaches the registration route is satisfied. The registration unit causes the registration information to include information of satellite positioning positions corresponding to registration points including the start point, the destination point and at least one passing point on the registration route; and the traveling control unit determines that the start condition is satisfied, when at least a distance condition where a distance between a current location as a current satellite positioning position and any one of the plurality of registration points is shorter than or equal to a reference distance is satisfied.

### CROSS-REFERENCE TO RELATED APPLICATION

This application is based on and claims the benefit of priority from earlier Japanese Patent Application No. 2025-053845 filed Mar. 27, 2025, the description of which is incorporated herein by reference.

### BACKGROUND

### Technical Field

The present disclosure relates to a traveling assistance apparatus.

### Description of the Related Art

A technique for assisting vehicle control from a registered start point to a parking location is known. For example, as a condition for activating the parking assist control, it is determined whether the vehicle is traveling in the vicinity of the start point of a registration route which is registered in accordance with a GPS location of the start location.

### SUMMARY

According to a first aspect of the present disclosure, a traveling assistance apparatus is provided. The traveling assistance apparatus includes: a registration unit that generates registration information as information related to a registration route from a start point to a destination point; and a traveling control unit that performs a traveling assistance control using the registration information to cause a vehicle to travel to the destination point when a start condition in which the vehicle approaches the registration route is satisfied.

### BRIEF DESCRIPTION OF THE DRAWINGS

The above-described objects and other objects, features and advantages of the present disclosure will be clarified further by the following detailed description with reference to the accompanying drawings.

In the accompanying drawings:

FIG. 1 is a block diagram of a system mounted on a vehicle;

FIG. 2 is a diagram for explaining registration information;

FIG. 3 is a diagram for explaining a traveling assistance function;

FIG. 4 is a flowchart showing a procedure of a registration process;

FIG. 5 is a flowchart showing a procedure of an assistance process;

FIG. 6 is a diagram for explaining effects and advantages achieved by performing the assistance process;

FIG. 7 is a first flowchart showing a procedure of the assistance process according to a second embodiment;

FIG. 8 is a second flowchart showing a procedure of the assistance process according to the second embodiment;

FIG. 9 is a first flowchart showing a procedure of the assistance process according to a third embodiment;

FIG. 10 is a second flowchart showing a procedure of the assistance process according to the third embodiment;

FIG. 11 is a third flowchart showing a procedure of the assistance process according to the third embodiment;

FIG. 12 is a diagram for explaining effects achieved by performing the assistance process according to the third embodiment;

FIG. 13 is a flowchart showing a procedure of part of the assistance process according to a fourth embodiment; and

FIG. 14 is a diagram for explaining a partial route and a registered partial route.

### DETAILED DESCRIPTION OF THE DRAWINGS

A technique for assisting a vehicle control from a registered start point to a parking location is known. For example, according to patent literature JP-A-2023-176548, as a condition for activating the parking assist control, it is determined whether the vehicle is traveling in the vicinity of the start point of a registration route which is registered in accordance with a GPS location of the start location.

In the case where the GPS location of the vehicle is acquired including some error, there is a concern that the parking assist may not be activated due to a determination that the vehicle is not traveling in the vicinity of the start point even when the vehicle is traveling in the vicinity of the start point of the registration route.

Hereinafter, embodiments of the present disclosure will be described.

### First Embodiment

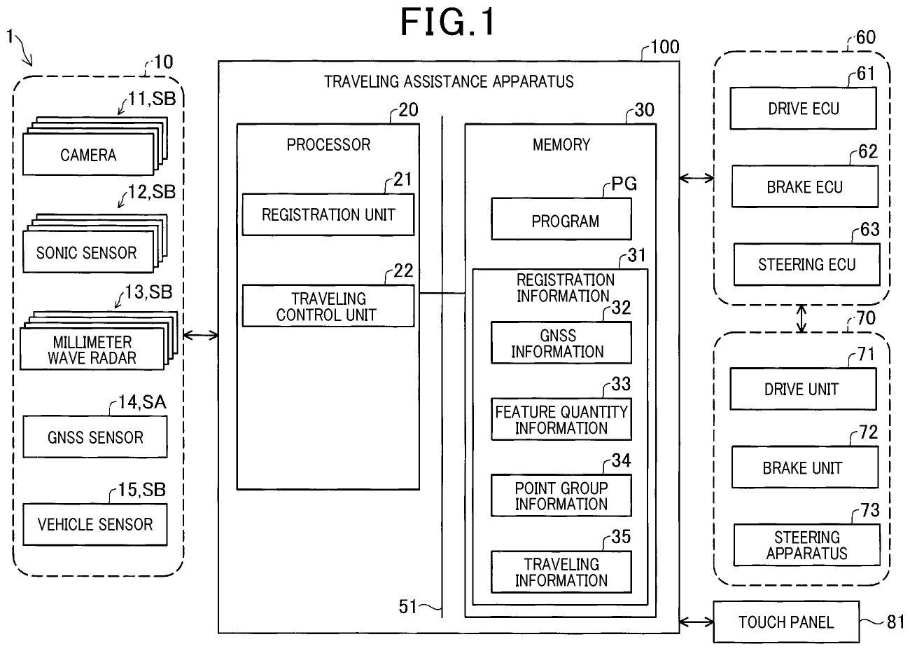

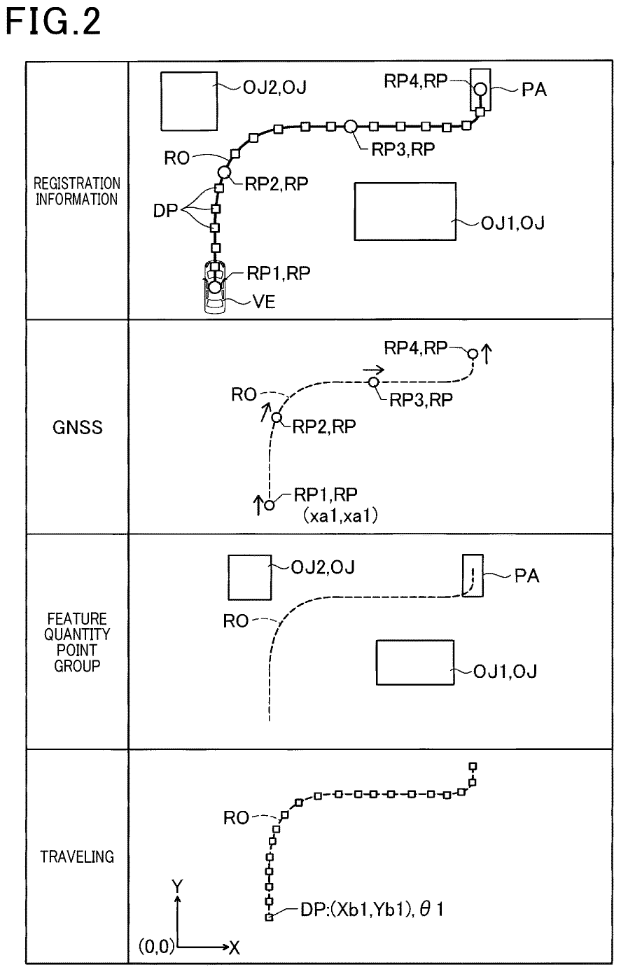

A system configuration of the present disclosure will be described below. A system 1 shown in FIG. 1 is mounted on a vehicle VE (shown in FIG. 2). As shown in FIG. 1, the system 1 is provided with a sensor 10, a traveling assistance apparatus 100, a traveling control ECU 60, a driving apparatus 70 and a touch panel 81.

The vehicle VE is configured to be capable of executing either an automatic driving and a manual driving. Automatic driving refers to a driving in a state where the traveling assistance apparatus 100 and other control apparatus (not shown) executes at least some of various control processes including a lighting control, a wiper control in addition to basic operations such as traveling, turning and stopping of the vehicle VE. On the other hand, manual driving refers to a driving in a state where passengers of the vehicle VE controls all of the above-described basic operations. The traveling assistance apparatus 100 is configured to be capable of communicating with the sensor 10, the traveling control ECU 60 and the touch panel 81 via an on-vehicle network. As the on-vehicle net work, for example, controller area network (AN), local interconnect network (LIN), Flex Ray or Ethernet (registered trademark) may be employed.

The sensor 10 includes a first sensor SA and a second sensor SB. The first sensor SA is configured to acquire a satellite positioning position and a satellite positioning direction using the satellite positioning system. The second sensor SC is capable of detecting an object OJ (shown in FIG. 2) around the vehicle VE and the trajectory of the vehicle VE. According to the present embodiment, the first sensor SA includes a GNSS sensor 14. According to the present embodiment, the second sensor SB includes a plurality of cameras 11, a plurality of sonic wave sensors 12, a plurality of millimeter wave radars 13 and a vehicle sensor 15. As another embodiment, the second sensor SB may be configured to include a LiDAR (light detection and ranging) device.

A plurality of cameras 11 are arranged at respective left and right positions in a front and rear sides of a vehicle body of the vehicle VE, for example. The respective cameras 11 capture images around the vehicle VE. The respective cameras 11 transmit the captured images to the traveling assistance apparatus 100. According to the present embodiment, the images captured by the respective cameras 11 include a road surface where the vehicle VE travels.

The plurality of sonic wave sensors 12 are arranged at respective left and right positions in a front and rear sides of a vehicle body of the vehicle VE, for example. The respective sonic wave sensors 12 emit sonic waves and receive reflected sonic waves reflected at an object OJ existing around the vehicle VE, thereby detecting the location of the object OJ and the distance between the vehicle VE and the object OJ. The respective sonic wave sensors 12 transmit point group data indicating the location of the object OJ and the distance between the vehicle VE and the object OJ to the traveling assistance apparatus 100.

The plurality of millimeter wave radars 13 are arranged at respective left and right positions in a front and rear sides of a vehicle body of the vehicle VE, for example. The respective millimeter wave radars 13 emit millimeter radar waves and receive reflected millimeter radar waves reflected at an object OJ existing around the vehicle VE, thereby detecting the location of the object OJ and the distance between the vehicle VE and the object OJ. The respective millimeter wave radars 13 transmit point group data indicating the location of the object OJ and the distance between the vehicle VE and the object OJ to the traveling assistance apparatus 100.

The GNSS sensor 14 is configured to include a GNSS (global navigation satellite system) receiver. The GNSS sensor 14 performs a positioning to detect a latitude and a longitude of the current location of the vehicle VE, based on received electromagnetic waves transmitted from the satellites that constitute the GNSS. The GNSS sensor 14 transmits the detected latitude and the longitude as the satellite positioning position to the traveling assistance apparatus 100.

The vehicle sensor 15 detects information related to traveling of the vehicle VE. The vehicle sensor 15 includes, for example, a wheel sensor, a steering angle sensor, a shift position sensor and the like. The wheel sensor detects the rotation speed of wheels of the vehicle VE. The steering angle sensor detects a steering angle of the vehicle VE. The shift position sensor detects state of shift of the vehicle VE. The state of shift refers to, for example, P, R and D. The vehicle sensor 15 transmits respective detection values to the traveling assistance apparatus 100.

The traveling assistance apparatus 100 is configured as a computer including a processor 20 and a memory 30 connected via an internal bus 51 to be communicable therebetween. The memory 30 is configured of a RAM, a ROM and the like. The processor 20 executes a computer program PG stored in advance in the memory 30, thereby serving as a registration unit 21 and a traveling control unit 22.

The registration unit 21 generates registration information 31 as information related to a registration route RO from a start point RP1 to a destination point RP4. The traveling control unit 22 performs, when a start condition in which the vehicle VE closely approaches the registration route RO is satisfied, a traveling assistance control for causing the vehicle VE to travel to the destination using the registration information 31.

The registration unit 21 generates registration information 31 and stores the registration information to the memory 30. The registration information includes GNSS information 32, feature quantity information 33, point group information 34 and traveling information 35.

FIG. 2 is an explanatory diagram showing the registration information 31. Also, FIG. 2 shows a registration route RO from the start point RP1 to the destination point RP4 in a map format. According to the present embodiment, the destination point RP4 is included in a parking area PA. The parking area PA is typically for a place where passengers frequently park a vehicle, for example, a parking space at home.

Note that GNSS in FIG. 2 is a diagram illustrating GNSS information 32. According to the present embodiment, the registration unit 21 calculates a satellite positioning position represented by coordinates on a two-dimensional plane and a satellite positioning direction using latitude and longitude transmitted from the GNSS sensor 14. That is, the GNSS information 32 includes the satellite positioning position and the satellite positioning direction determined by the GNSS sensor 14. Here, the satellite positioning direction refers to the direction of travel of the vehicle VE. Hereinafter, the satellite positioning position and the satellite positioning direction determined by the GNSS sensor 14 are also referred to as a ‘GNSS location’ and a ‘GNSS direction’, respectively. In FIG. 2, the GNSS direction is indicated by an arrow.

The GNSS information 32 includes, in addition to respective information of the start point RP1 and the destination point RP4, information of passing points RP2 and RP3 as a plurality of passing points from the start point RP1 to the destination point RP4. The start point RP1, the destination point RP4 and the passing points RP2 and RP3 are collectively referred to as registration point RP.

The feature quantity and point group shown in FIG. 2 illustrates the feature quantity information 33 and the point group information 34. In the feature quantity and the point group shown in FIG. 2, a case is exemplified in which the vehicle VE traveling on the registration route RO detects the first object OJ1 and the second object OJ2 as two objects OJ, and the parking area PA. Specifically, a detection of the parking area PA refers to a detection of a white marking painted on the ground to identify the parking are PA. In this case, the registration unit 21 extracts, as the feature quantity, edges of the white marking included in the captured image of the camera 11. Further, the point group information 34 includes point group data of the sonic sensor 12 and the millimeter wave radar 13 which capture the first object OJ1 and the second object OJ2. Hereinafter, the feature quantity information 33 and the point group information 34 are collectively referred to as object information.

The feature quantity information 33 and the point group 34 are an example of an object OJ around the vehicle VE. Note that terrain such as the ground is also included as object OJ.

Note that ‘traveling’ shown in FIG. 2 illustrates traveling information 35. As shown in ‘traveling’ of FIG. 2, the traveling information 35 includes a coordinate of the plurality of traveling positions DP. The coordinate of the traveling information 35 is expressed by a coordinate of a two-dimensional plane of which the origin is the reference position. The reference position is a position at which the vehicle VE starts to travel. When comparing the coordinate of the traveling information 35 and the coordinate of the GNSS location, the vehicle sensor 15 is used for calculating the coordinate of the traveling information 35, but the GNSS sensor 14 is used for calculating the coordinate of the GNSS location.

The plurality of traveling positions DP represents a trajectory in which the vehicle VE travels. That is, the traveling information 35 is an example of the trajectory information as information of the trajectory of the vehicle VE.

The registration unit 21 utilizes, when generating the traveling information 35, detection values of the wheel speed sensor and the steering angle sensor detected in a period from the reference position to the current location, and calculates a coordinate of which the origin is the reference position and an angle formed between a straight line connecting the reference position and the current location and the reference line in the coordinate system. Hereinafter, the position and the angle acquired using the vehicle sensor 15 are also referred to as a traveling coordinate position and a traveling coordinate angle, respectively. As shown in FIG. 2, intervals between the traveling positions DP are shorter than intervals between the registration points RP.

In the registration information 31, the GNSS information 32, the feature quantity information 33, the point group information 34, and the traveling information 35 are each associated with positions on the registration route RO.

When estimating the own location in the traveling assistance operation, with the initial location as the GNSS location acquired using the signals transmitted from the GNSS sensor 14, the traveling control unit 22 utilizes detection signals transmitted from the camera 11, the sonic sensor 12, the millimeter wave radar 13 and the vehicle sensor 15 and the registration information 31, and estimate the own location. It is known that the GNSS coordinate may be calculated including an error such as several tens of meters. In this respect, the traveling control unit 22 estimates the own location using the detection value of the second sensor SB and the registration information 31, whereby the accuracy of the own location can be improved. Thus, the traveling assistance control can be smoothly performed.

Specifically, the traveling control unit 22 acquires, from the memory 30, the feature quantity information 33, the point group information 34, and the traveling information 35 that are associated with positions on the registration route RO indicated by the GNSS coordinates, and performs an self-location estimation by comparing these items of information with detection values of the second sensor SB to estimate the own location.

In more detail, the traveling control unit 22 analyzes the image transmitted from the camera 11 to acquire feature quantity. Then, the traveling control unit 22 performs a matching between the acquired feature quantity and the feature quantity information 33. Also, the traveling control unit 22 performs a matching between the point group data transmitted from the sonic sensor 12 and the millimeter wave radar 13 and the point group information 34. The traveling control unit 22 utilizes the matching result of the feature quantity information 33 and the matching result of the point group information 34 to attempt a self-location estimation as an estimation of the own location indicating a relative location of the vehicle VE relative to the object OJ. The traveling control unit 22 outputs the coordinate of the own location when succeeding the self-location estimation and outputs information indicating that the estimation cannot be performed when failing the self-location estimation. In other words, the traveling control unit 22 performs a self-location estimation using a location indicated by the GNSS coordinate as an initial location, and outputs the coordinate of the own location as an estimation result when succeeding the self-location estimation. For example, in the case where an error occurring between the initial location and the actual location of the vehicle VE is large, that is, an error in the GNSS coordinate is large, the traveling control unit 22 fails the self-location estimation.

As shown in FIG. 1, the traveling control ECU 60 includes a drive ECU 61, a brake ECU 62 and a steering ECU 63. As other embodiment, the traveling control ECU 60 may be configured to include an upper ECU that integrates the drive ECU 61, the brake ECU 62 and the steering ECU 63.

The drive ECU 61 serves as an electromagnetic control unit that controls a drive actuator that controls the driving source producing the driving force of the vehicle VE such as an engine or an electric motor. In the case where the driver manually drives the vehicle, the drive ECU 61 controls the drive actuator depending on an operation quantity of the accelerator pedal. When an automatic driving is performed, the drive ECU 61 controls the drive actuator of the driving source depending on a required driving force calculated by the traveling control unit 22.

The brake ECU 62 serves as an electronic control unit that controls a brake actuator for producing the braking force of the vehicle VE. In the case where the driver manually drives the vehicle, the brake ECU 62 controls the brake actuator depending on the operation quantity of the brake pedal. When performing the automatic driving, the brake ECU 62 controls the brake actuator so as to produce a brake oil pressure depending on the required braking force calculated by the traveling control unit 22.

The steering ECU 63 serves as an electronic control unit that controls a steering actuator for producing the steering torque of the vehicle VE. In the case where the driver manually drives the vehicle, the steering ECU 63 controls the steering actuator depending on an operation of the steering wheel. In the case where automatic driving is performed, the steering ECU 63 controls the steering actuator depending on the required steering angle calculated by the traveling control unit 22.

The driving apparatus 70 includes a drive unit 71, a brake unit 72, a steering unit 73 and the like. The drive unit 71 is provided with a drive source and a drive actuator that controls the drive source. The drive actuator operates in response to a control signal of the drive ECU 61. The brake unit 72 is provided with a brake mechanism of the vehicle VE and a brake actuator that controls the brake mechanism. The brake actuator operates in response to a control signal of the brake ECU 62. The steering unit 73 is provided with a steering mechanism of the vehicle VE and a steering actuator that controls the steering mechanism. The steering actuator operates in response to the control signal of the steering ECU 63.

When the system 1 performs a traveling assistance operation, the traveling control ECU 60 transmits a control signal to the driving apparatus 70 in accordance with a control of the traveling control unit 22, thereby performing the automatic driving. Note that the control signal refers to a signal indicating the above-descried required driving force, required braking force and required steering angle. The required driving force, required braking force and the required steering angle are also referred to as control quantity.

The touch panel 81 displays information such as map information and displays a selection button, and recurve a command from the passenger.

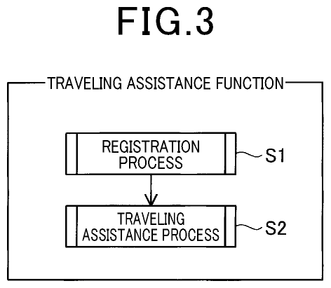

Hereinafter, a traveling assistance function will be described. As shown in FIG. 3, the traveling assistance function is accomplished by executing a registration process at step S1 and a travelling assistance process at step S2. The registration process registers a route from the start point RP1 to the destination point RP4. The traveling assistance process performs travelling assistance to cause the vehicle to travel along the registration route.

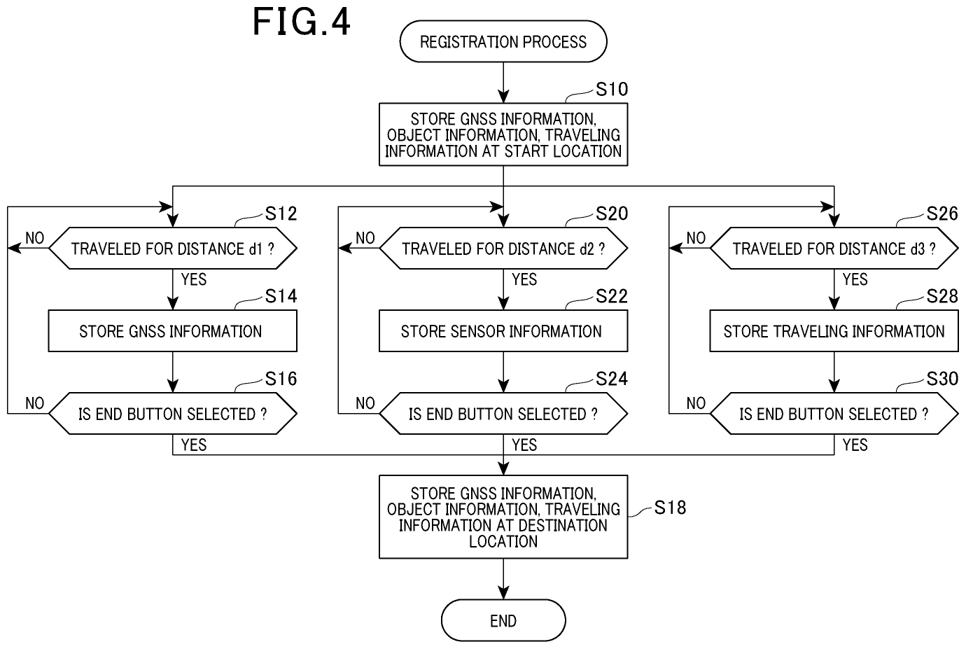

The registration process will be described. The passenger uses the touch panel 81 to command the traveling assistance apparatus 100 to perform a registration process. Specifically, the passenger on the vehicle VE touches a registration activation button on the touch panel 81 to be selected for activating the selected registration displayed on the touch panel 81 from a desired start point RP1. The registration unit 21 activates the registration process shown in FIG. 4 once the registration activation button is selected.

As shown in FIG. 4, at step S10, the registration unit 21 acquires detected values from the sensor 10 and stores the GNSS information at the start point RP1, the feature quantity information 33 and the traveling information 35 into the memory 30.

Note that processes from the next step S12 to step 16, processes from step S20 to step S24, and processes from step S26 to step S30 are executed in parallel.

At step S12, the registration unit 21 determines, using a vehicle speed sensor, whether the vehicle travels for a predetermined distance d1. The distance d1 is, for example, 10 meters. At step S12, when the registration unit 21 determines that the vehicle does not travel for the distance d1, the process returns to step S12 after a predetermined period of time has elapsed. The predetermined period of time may be, for example, about 1 millisecond. According to present processing routine of the present embodiment, the predetermined period of time when returning the processing step is set to be the same for all cases.

At step S12, when determined that the vehicle travels for the distance d1, the registration unit 21 acquires the detection values from the sensor 10 at step S14, and stores the GNSS information 32 generated using the acquired detection values into the memory 30.

The passenger on the vehicle VE selects an end button (not shown) by touching a button displayed on the touch panel 81 after the vehicle reaches the destination point RP4 and the vehicle is parked in a parking area PA.

At step S16, the registration unit 21 determines whether the end button (not shown) displayed on the touch panel 81 is selected. At step S16, when determined that the end button is not selected, the registration unit 21 returns the process to step S12 after a predetermined period of time has elapsed. Thus, the GNSS information of passing points from the start point RP1 to the destination location RP4 is stored into the memory 30. At step S16, when determined that the end button is selected, the registration unit 21 advances the process to step S18.

At step S20, the registration unit 21 utilizes the vehicle speed sensor to determine whether the vehicle VE travels for a predetermined distance d2. The distance d2 is, for example, several meters. At step S20, when determined that the vehicle VE does not travel for the distance d2, the registration unit 21 returns the process to step S20 after a predetermined period of time has elapsed. Note that the distance d2 is set depending on respective detection regions corresponding to the sonic sensor 12 and the millimeter wave radar 13. The distance d2 may preferably be set so as to cover information about objects OJ around the registration route RO.

When determined that the vehicle travels for the distance d2 at step S20, the registration unit 21 acquires detection values of the sensor 10 at step S22, and stores object information generated using the acquired detection values into the memory 30.

At step S24, similar to step S16, the registration unit 21 determines whether the end button is selected. At step S24, when determined that the end button is not selected, the registration unit 21 returns the process to step S20 after a predetermined period of time has elapsed. When determined that the end button is selected at step S24, the registration unit 21 advances the process to step S18.

At step S26, the registration unit 21 determines whether the vehicle VE travels for a predetermined distance d3 using the vehicle speed sensor. The distance d3 is, for example, 1 meter. The distance d3 is set to be shorter than a distance d1. At step S26, when determined that the vehicle does not travel for the distance d3, the registration unit 21 returns the process to step S26 after a predetermined period time has elapsed.

When determined that the vehicle travels for a distance d3 at step S26, the registration unit 21 acquires detection values of the sensor 10 at step S28, and stores the traveling information 35 generated using the acquired detection values into the memory 30.

At step S30, similar to step S16, the registration unit 21 determines whether the end button is selected. At step S30, when determined that the end button is not selected, the registration unit 21 returns the process to step S30 after a predetermined period of time has elapsed. When determined that the end button is selected at step S30, the registration unit 21 advances the process to step S18.

At step S18, the registration unit 21 acquires the detection values from the sensor 10, stores the GNSS information 32 at the destination location RP4, the feature quantity information 33 and the traveling information 35 which are generated using the acquired detection values, into the memory 30 and terminates the present routine.

The registration process is performed, whereby the registration unit 21 generates the registration information 31, and the generated registered information is stored into the memory 30.

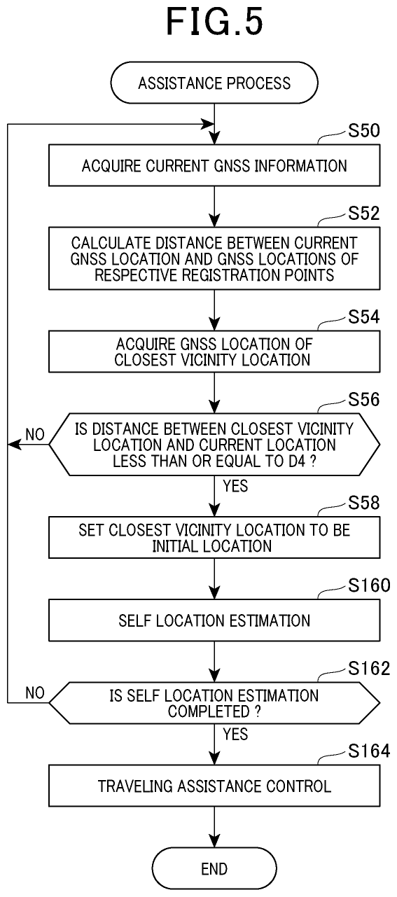

Next, assistance process will be described. The traveling control unit 22 activates an assistance process shown in FIG. 5 once the vehicle VE starts to travel. As other embodiments, the traveling control unit 22 may activate the assistance process in response to the vehicle speed being reference vehicle speed or lower. The reference speed according to the present embodiment is, for example, 30 km/h.

At step S50 shown in FIG. 5, the traveling control unit 22 acquires detection values from the sensor 10 and acquires current GNSS information 32 of the vehicle VE. At step S52, the traveling control unit 22 calculates distances between respective registered points RP and the current GNSS location. At step S54, the traveling control unit 22 determines a registration point RP having the shortest distance calculated at step S52 among the plurality of registration points RP to be the closest vicinity location, and acquires the GNSS location corresponding to the closest vicinity location.

At step S56, the traveling control unit 22 determines whether a distance between the GNSS location corresponding to the closest vicinity location and the current location as a current GNSS location is shorter than or equal to the reference distance d4. The reference distance d4 is, for example, 70 meters. At step S56, when determined that the distance between the GNSS location corresponding to the closest vicinity location and the current GNSS location is not shorter than or equal to the reference distance d4, since the vehicle VE is not traveling near the registration route RO, the traveling control unit 22 returns the process to step S50.

At step S56, when determined that the distance between the GNSS location of the closest vicinity location and the current GNSS location is shorter than or equal to the reference distance d4, the traveling control unit 22 sets the closest vicinity location to be the initial location of the self-location estimation. Speciffiaclly, the traveling control unit 22 extracts object information associated with the closest vicinity location.

At step S160, the traveling control unit 22 attempts a self-location estimation. Specifically, the traveling control unit 22 compares the detection values acquired from the sensor 10 with the object information extracted at step S58, thereby performing the self-location estimation. As described above, the traveling control unit 22 acquires a location coordinate when the self-location estimation is succeeded.

At step S162, the traveling control unit 22 determines whether the self-location estimation is successfully completed. When the self-location estimation is not successfully completed, the traveling control unit 22 returns the process to step S50.

At step S162, when the self-location estimation is successfully estimated, since the start condition of the traveling assistance control is satisfied, the traveling control unit 22 performs a traveling assistance control.

Specifically, as a result of self-location estimation, when the current location of the vehicle is on the registration route RO, the traveling control unit 22 calculates a control quantity to be commanded to the traveling control ECU 60, using a location ahead on the registration route RO as a temporal destination location. Then, the traveling control unit 22 transmits a control signal including the calculated control quantity to the traveling control ECU 60. As a result of the self-location estimation, when the current location of the vehicle is not on the registration route RO, the traveling control unit 22 calculates a control quantity to be commanded to the traveling control ECU 60, using, as a temporal destination location, a location on the registration route RO at which the vehicle can merge so as to return to the registration route RO. The traveling control unit 22 then transmits a control signal including the calculated control quantity to the traveling control ECU 60. The traveling control unit 22 repeatedly performs self-location estimation and calculation of the control quantity until the vehicle VE reaches the destination location RP4. The traveling control ECU 60 controls the driving apparatus 70 in accordance with the transmitted control signal. Thus, the vehicle VE travels to the destination location RP4 by automatic driving. When completing the process at step S164, the traveling control unit 22 terminates the present processing routine.

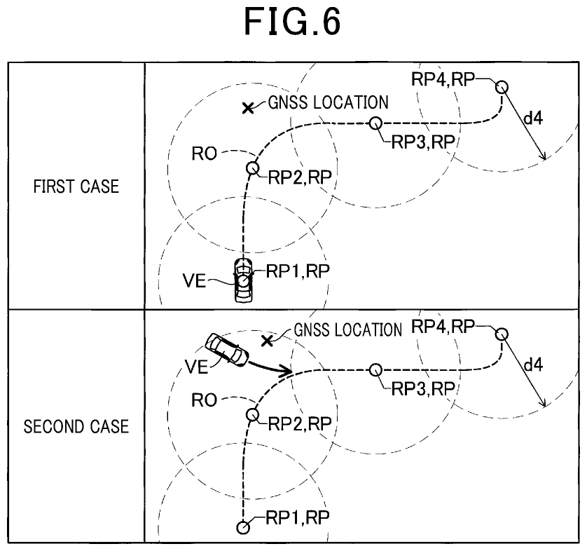

With reference to FIG. 6, effects and advantages of the assistance process will be described. In FIG. 6, ‘first case’ exemplifies a case where an error between the GNSS location and the actual location of the vehicle VE is relatively large. In this case, when the start condition is limited to only that the distance between the start location RP1 and the current GNSS location is shorter than or equal to the reference distance d4, the location of the vehicle VE may not be determined as vicinity of the start location RP1 even when the vehicle VE is traveling on the registration route RO, and then the traveling assistance control may not be performed. In this respect, according to the present embodiment, a distance between any one of the plurality of registration points RP and the current GNSS location becomes shorter than or equal to the reference distance d4, and when succeeding the self-location estimation, the traveling assistance control is performed. Note that ‘first case’ shown in FIG. 6 refers to a case where a distance between the GNSS location and the passing point RP2 is shorter than or equal to the reference distance d4, although the distance between the GNSS location and the start point RP1 is longer than the reference distance d4. Hence, a case where the traveling assistance control is not performed although the vehicle VE is traveling in the vicinity of the registration route RO can be mitigated.

In ‘second case’ of FIG. 6, an example is illustrated in which the vehicle VE travels from a route different from the registration route RO and merges into the registration route RO. Even in this case, when the start condition is limited to only that the distance between the start point RP1 and the current GNSS location shorter than or equal to the reference distance d4, there is a possibility that traveling assistance control may not be performed. In this regard, according to the present embodiment, not only the start location RP1 but also any one of a plurality of registration points RP is used, when the distance between any one of these locations and the current GNSS location becomes shorter than or equal to the reference distance d4 and self-location estimation succeeds, the traveling assistance control is performed. Therefore, even when the vehicle VE travels from a route different from the registration route RO to the destination location RP4, the traveling assist control can be executed.

Although the above description refers to errors in the GNSS location during the assistance process, the GNSS location acquired during the registration process also includes errors. In the above-described assistance process, not only errors in the GNSS location during the assistance process but also errors in the GNSS location acquired during the registration process may be present. For the same reasons described above, a case where the traveling assistance control is not performed due to errors in the GNSS location can be mitigated.

The condition (distance condition) that is satisfied when a determination is ‘YES’ at step S56, that is, the distance between the current GNSS location (i.e., the current location) and any one of the plurality of registration points RP is shorter than or equal to the reference distance d4, is also referred to as a first condition. The condition that is satisfied when a determination is ‘YES’ at step S162, that is, the self-location estimation succeeds, is also referred to as a second condition.

According to the above-described first embodiment, the traveling assistance apparatus 100 is provided with the registration unit 21 and the traveling control unit 22. The registration unit 21 acquires GNSS location from the GNSS sensor 14 and generates the registration information 31 including information of the GNSS location. The traveling control unit 22 attempts a self-location estimation at step S160, when determining at step S56 that the distance between the GNSS location of the closest vicinity location and the current GNSS location is shorter than or equal to the reference distance d4. Then, when determined that the self-location estimation is succeeded at step S162, since the start condition of the traveling assistance process is satisfied, the traveling control unit 22 performs the traveling assistance control at step S164. The registration information 31 includes a plurality of GNSS locations. Hence, even in a case where an error occurring between the current GNSS location and an actual location of the vehicle VE is relatively large, the traveling assistance control can be activated when any one of the plurality of GNSS locations and the current GNSS location is shorter than or equal to the reference distance d4. Accordingly, occurrence of a case where the traveling assistance control is not activated even when the vehicle approaches the registration route RO can be suppressed. Further, even in a case where the vehicle VE travels by merging onto the registration route RO at an intermediate point, the traveling assistance control can be activated.

Moreover, the registration unit 21 attempts the self-location estimation after determining that the GNSS location of the closest vicinity location and the current GNSS location is shorter than or equal to the reference distance d4, and activates the traveling assistance control when the self-location estimation is succeeded. Thus, the traveling control unit 22 is able to perform the traveling assistance control smoothly by utilizing the self-location.

### Second Embodiment

In the second embodiment, the content of the assistance process differs from that of the first embodiment. Note that constituents and processing steps that are the same as those in the above-described embodiment are denoted by the same reference numerals, and detailed descriptions thereof will be omitted as needed.

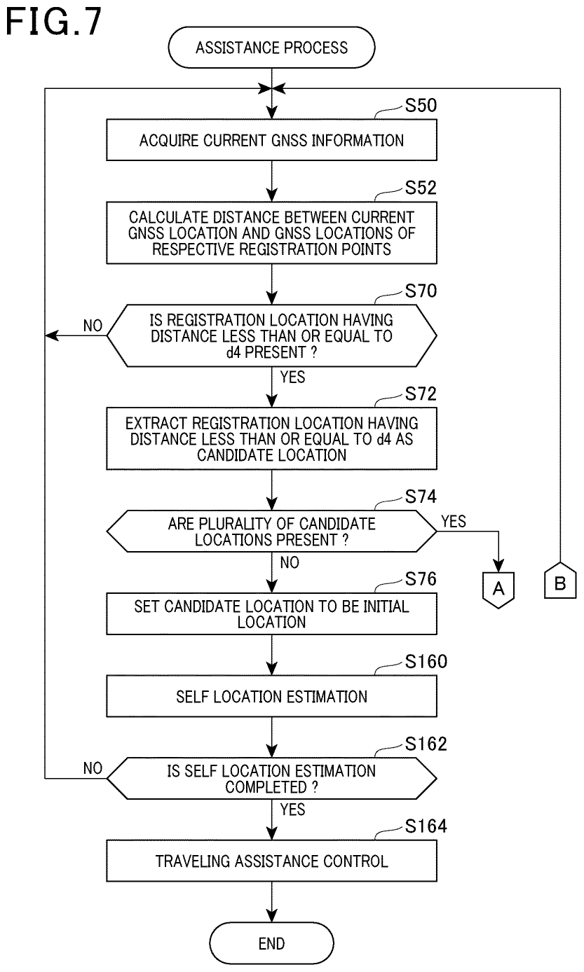

The traveling control unit 22 executes processes at step S50 and step S52 shown in FIG. 7 similar to those in the first embodiment. At step S70, the traveling control unit 22 determines, among the plurality of registration points RP, whether a registration point RP of which the distance to the current GNSS location is shorter than or equal to the reference distance d4 is present. When determined at step S70 that the registration point RP of which the distance to the current GNSS location is shorter than or equal to the reference distance d4 is not present, the traveling control unit 22 returns the process to step S50.

At step S70, when determined that a registration point RP of which the distance to the current GNSS location is shorter than or equal to the reference distance d4 is present, the traveling control unit 22 extracts, at step S72, the registration point RP of which the distance to the current GNSS location is shorter than or equal to d4 to be a candidate location.

At step S74, the traveling control unit 22 determines whether a plurality of candidate locations are present. When determined at step S74 that a plurality of candidate locations are not present, then at step S76, the traveling control unit 22 sets the sole candidate location as the initial location. Thereafter, the traveling control unit 22 executes processes at steps S160 to S164 in the same manner as in the first embodiment.

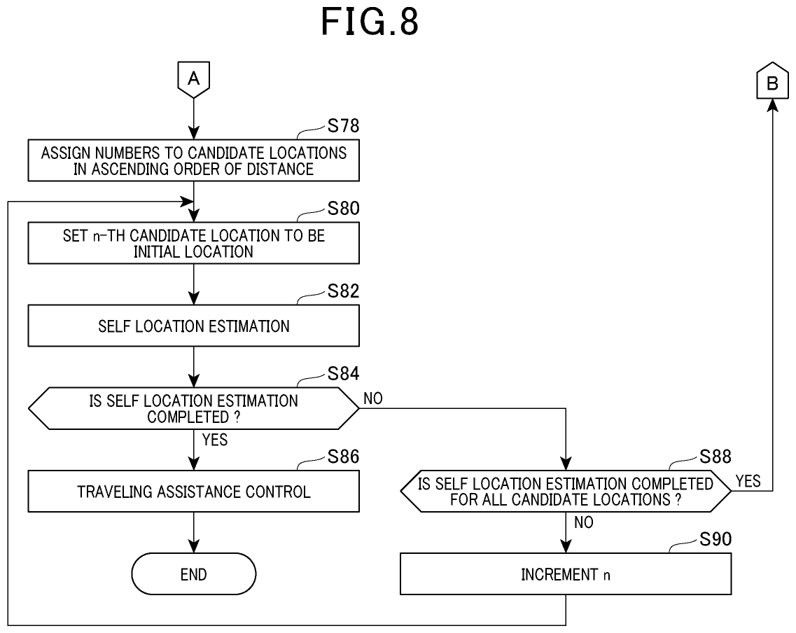

When determined at step S74 that a plurality of candidate locations are present, then at step S78 shown in FIG. 8, the traveling control unit 22 assigns numbers to the candidate locations in ascending order of distance from the current GNSS locations. Also, the traveling control unit 22 sets a variable n used in the processes to the initial value ‘1’. This is done in order to preferentially set the candidate locations as the initial location and attempts self-location estimation in ascending order of distance from the current GNSS location when a plurality of candidate locations are present. Here, ‘preferentially in ascending order of distance from the current GNSS location’ means that self-location estimation is attempted by setting each candidate location as the initial location in ascending order of distance from the current GNSS location, and when the self-location estimation succeeds, self-location estimation is not performed for the other candidate locations for which self-location estimation has not yet been executed.

At step S80, the traveling control unit 22 sets the n-th candidate locations as the initial location. In other words, at step S80, which is performed first, the first candidate location that is, the candidate location closest to the current location is set as the initial location.

The traveling control unit 22 sequentially executes processes at step S82, step S84, and step S86. Each of processes at steps S82, S84, and S86 is executed in the same manner as processes at steps S160, S162, and S164, respectively. Therefore, a detailed explanation is omitted.

When determined at step S84 that self-location estimation cannot be performed, then at step S88, the traveling control unit 22 determines whether self-location estimation has been performed for all candidate locations. When determined at step S88 that self-location estimation has not been performed for all candidate locations, the traveling control unit 22 attempts self-location estimation using the next candidate location. Accordingly, at step S90, the variable n is incremented, and the process returns to step S80.

When determined at step S88 that self-location estimation has been performed for all candidate locations, the traveling control unit 22 returns the process to step S50 in FIG. 7. In this case, it means that self-location estimation has failed for all candidate locations.

According to the above-described second embodiment, the same effects and advantages as those in the first embodiment can be achieved. When a plurality of candidate locations are present, the traveling control unit 22 preferentially sets the candidate locations as the initial location in ascending order of distance from the current location and performs self-location estimation (S82). Thus, for example, when the current GNSS location is located between two adjacent registration points RP on the registration route RO, self-location estimation can be performed using each of these two registration points RP. Depending on the error of the GNSS location, the closest registration point RP does not necessarily correspond to the actual vehicle location. Hence, according to the present embodiment, by performing self-location estimation using a plurality of candidate locations, the probability of successfully estimating the self-location can be increased.

### Third Embodiment

The assistance process of the third embodiment differs from that of the second embodiment in the processing executed after a ‘YES’ determination is made at step S72 of the second embodiment. Note that constituents and processing steps that are the same as those in the second embodiment are denoted by the same reference numerals, and detailed descriptions thereof are omitted.

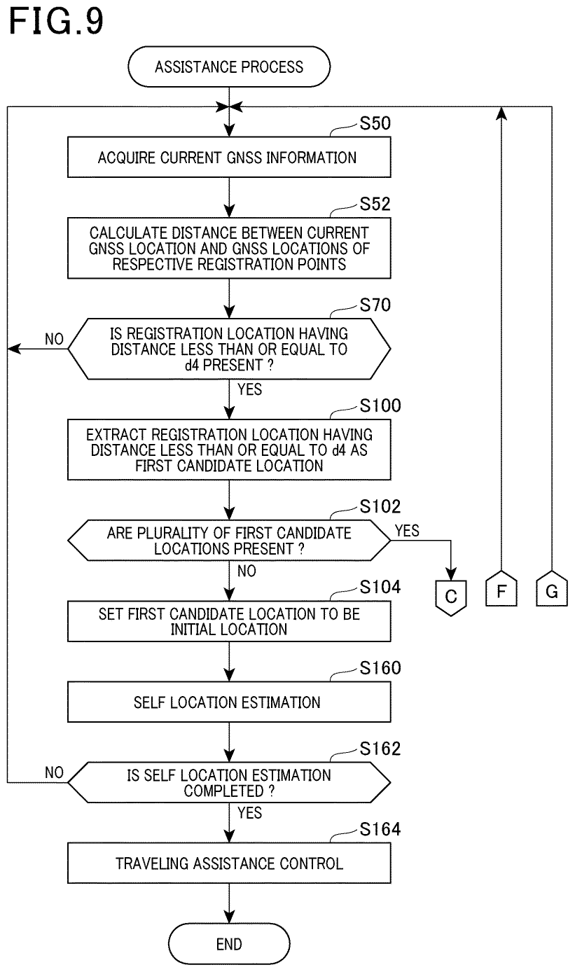

As shown in FIG. 9, the traveling control unit 22 executes processes at steps S50 to S70 in the same manner as in the second embodiment. At step S70, when determined that registration point RP of which the distance from the current GNSS location is shorter than or equal to the reference distance d4, then at step S100, the traveling control unit 22 extracts the registration point RP of which the distance from the current GNSS location is shorter than or equal to the reference distance d4 as a first candidate location.

At step S102, the traveling control unit 22 determines whether a plurality of first candidate location are present. When determined at step S102 that no plurality of first candidate locations is present, then at step S104, the traveling control unit 22 sets the sole first candidate location as the initial location. Subsequently, the traveling control unit 22 executes processes at steps S160 to S164 in the same manner as in the first embodiment.

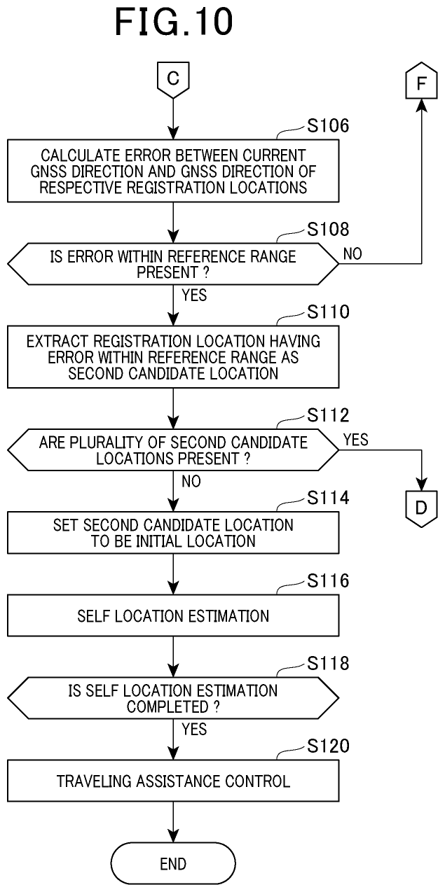

At step S102, when determined that a plurality of first candidate locations are present, at step S106 shown in FIG. 10, the traveling control unit 22 calculates, for each of a plurality of first candidate locations, an error between the direction of the GNSS at the current location and the direction of the GNSS at respective registration points RP.

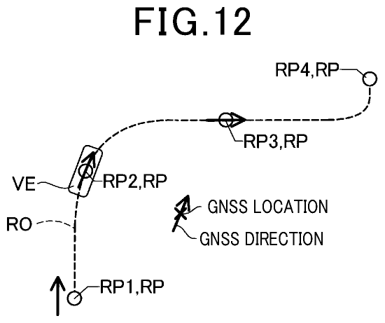

Here, with reference to FIG. 12, a situation assumed in the present embodiment will be described. In FIG. 12, the arrows indicate the GNSS direction. In FIG. 12, the actual vehicle VE is traveling near the passing point RP2, and a case is exemplified in which the GNSS location is acquired with an error.

The current GNSS location is approximately equidistant from the passage points RP2 and RP3. Therefore, at step S102, the passage points RP2 and RP3 are extracted as first candidate locations.

At step S106, an error between the direction of the current GNSS location and the directions of the GNSS locations in the respective registration points RP is calculated as, for example, from 0 degree to 180 degrees.

At step S108 of FIG. 10, the traveling control unit 22 determines whether there is any registration position RP for which the calculated error falls within a predetermined reference range. When determined at step S108 that there is no registration position RP within the reference range, the traveling control unit 22 returns the process to step S50 of FIG. 9. When determined at step S108 that there is a registration position RP within the reference range, then at step S110, the traveling control unit 22 further extracts, from among the second candidate locations, the registration position RP of which error falls within the reference range as a second candidate location.

At step S112, the traveling control unit 22 determines whether there are a plurality of second candidate locations. When determined at step S112 that there are not a plurality of second candidate locations, then at step S114 the traveling control unit 22 sets the sole second candidate location as the initial position. Thereafter, the traveling control unit 22 executes processes at steps S116 to S120. Since each of steps S116 to S120 is the same as the corresponding one of steps S160 to S164, a description thereof will be omitted.

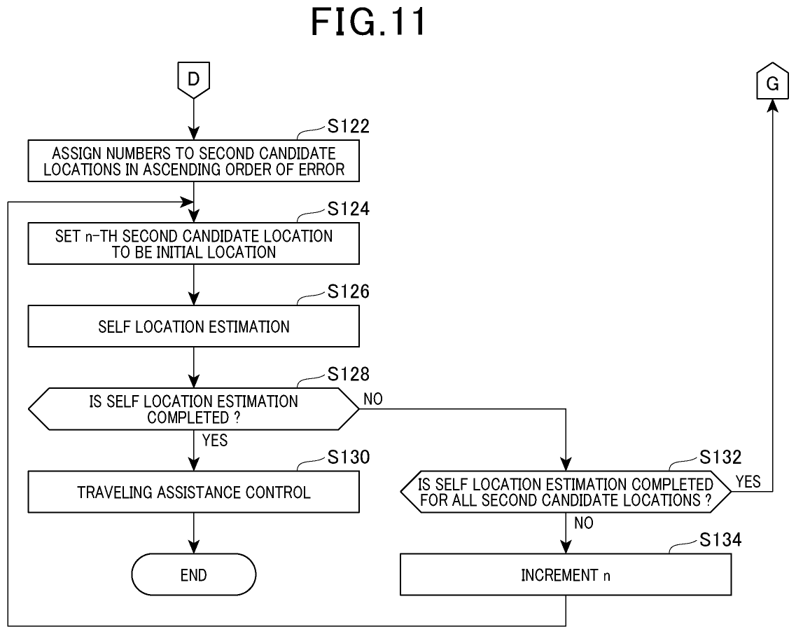

When determined at step S112 that there are a plurality of second candidate locations, then at step S122 of FIG. 11, the traveling control unit 22 assigns numbers to the second candidate locations in ascending order of error (i.e. from the smallest error to the largest). The traveling control unit 22 also sets a variable n, used in the processing, to an initial value of ‘1’.

At step S124, the traveling control unit 22 sets the n-th second candidate location as the initial position. The traveling control unit 22 then sequentially executes processes at step S126, step S128, and step S130. Since each of steps S126, S128, and S130 is executed in the same manner as the corresponding one of steps S160, S162, and S164, a description thereof will be omitted.

When determined at step S128 that self-location estimation cannot be performed, then at step S132 the traveling control unit 22 determines whether self-location estimation has been performed for all second candidate locations. When determined at step S132 that self-location estimation has not been performed for all second candidate locations, the traveling control unit 22 increments the variable n at step S134 and then returns the process to step S124.

At step S132, when determined at step S132 that self-location estimation has been performed for all second candidate locations, the traveling control unit 22 returns the process to step S50 in FIG. 9. In this case, it means that self-location estimation has failed for all second candidate locations.

In the example shown in FIG. 12, the error between the passing point RP2 and the current GNSS direction is smaller than the error between the passing point RP3 and the current GNSS direction. Hence, by performing the assistance process according to the present embodiment, the passing point RP2 having a smaller GNSS direction error is set as the initial location for the self-location estimation before the passing point RP3. When the passing position RP2 having a smaller GNSS direction error is used for self-location estimation, the probability of successfully estimating the self-location is higher than when using the passing location RP3. Accordingly, by preferentially attempting self-location estimation for a plurality of second candidate locations in ascending order of GNSS direction error, the self-location can be estimated efficiently.

According to the third embodiment described above, the traveling control unit 22 preferentially sets, as the initial location, candidate locations in ascending order of the error between the current GNSS direction and the GNSS direction of the registration position RP, and attempts self-location estimation. Accordingly, in the present embodiment, the self-location can be estimated efficiently.

### Fourth Embodiment

The assistance process of the fourth embodiment differs from that of the second embodiment in part of its processing steps. Note that constituents and processing steps that are the same as those in the second embodiment are denoted by the same reference numerals, and detailed descriptions thereof are omitted as appropriate. Further, a portion of the assistance process in the present embodiment is performed in the same manner as in the second embodiment. Therefore, the processing flow executed in the same manner as in the second embodiment will be described with reference to FIG. 7.

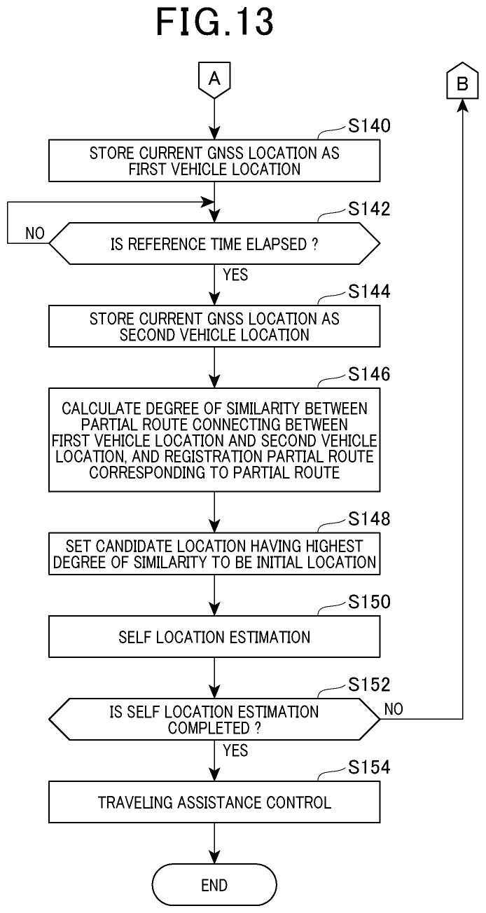

The travel control unit 22 executes processes at steps S50 to S74 shown in FIG. 7. When determined at step S74 that there are not a plurality of candidate locations are present, processes at steps S76 to S164 are executed. When determined at step S74 that there are a plurality of candidate locations, then at step S140 of FIG. 13, the current GNSS location is stored into the memory 30 as a first vehicle location. At step S142, the traveling control unit 22 determines whether a predetermined reference time has elapsed. The reference time is, for example, one second. When determined at step S142 that the reference time has not elapsed, the traveling control unit 22 waits until a predetermined time has elapsed and then returns the process to step S142. This predetermined time is, for example, approximately 1 millisecond.

When determined at step S142 that the reference time has elapsed, the traveling control unit 22 acquires, at step S144, the current GNSS location and stores the acquired GNSS location into the memory 30 as a second vehicle location.

At step S146, the traveling control 22 calculates a degree of similarity between a partial route connecting between the first vehicle location and the second vehicle location, and a registration partial route corresponding to the partial route.

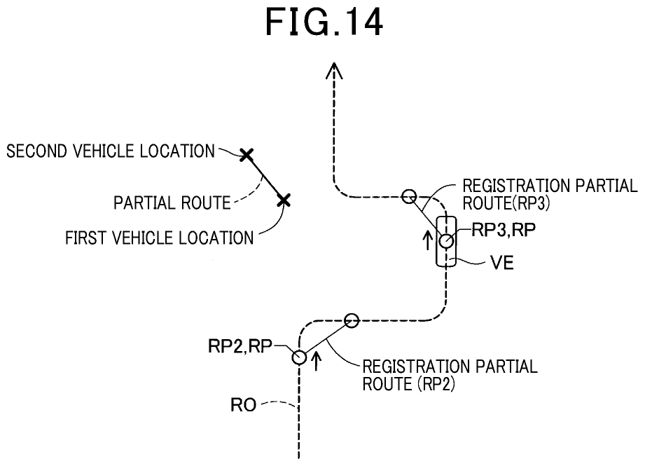

FIG. 14 is a diagram for explaining a partial route and a registration partial route. In FIG. 14, a case is exemplified in which an actual vehicle VE is traveling at passing point RP3, and the GNSS location is acquired with an error. In FIG. 14, the distance between the first vehicle location and passing point RP2 and the distance between the first vehicle location and passing point RP3 are approximately the same, and passing point RP2 and passing point RP3 are extracted as candidate locations. The GNSS direction at the passing point RP2 and the GNSS direction at the passing point RP3 are substantially the same.

A partial route is defined by a line segment connecting the first vehicle location and the second vehicle location. A registration partial route is also defined by a line segment. The registration partial route for the passing point RP2 and the registration partial route for the passing point RP3 are set in the same manner. Therefore, here, the registration partial route will be described representatively using the registration partial route of the passing point RP2.

One end of the registration partial route for passing point RP2 is passing point RP2. According to the present embodiment, the other end of the registration partial route for the passing point RP2 is a position on the registered route RO that is separated from passing point RP2 by a route length equal to the route length traveled by the actual vehicle VE during the reference time, along the registration route RO. In another embodiment, the other end of the registration partial route for the passing point RP2 may be a position on the registration route RO that is separated from the passing point RP2 by a distance equal to the distance traveled by the actual vehicle VE during the reference time.

According to the present embodiment, the traveling control unit 22 converts each of the partial route and the registration partial route into vectors, and calculates a cosine similarity as the degree of similarity between the partial route and the registration partial route. The traveling control unit 22 defines the direction from the first vehicle location toward the second vehicle location as the direction of the vector.

At step S148 of FIG. 13, the traveling control unit 22 sets the candidate location having the highest degree of similarity, that is, the most similar candidate location, as the initial location for the self-location estimation. At step S150, the traveling control unit 22 performs a self-location estimation. At step S152, the traveling control unit 22 determines whether the self-location estimation has been successfully performed. When determined at step S152 that the self-location estimation has been successfully performed, then at step S154, the traveling control unit 22 performs a traveling assistance control and terminates the present process routine. When determined at step S152 that the self-location estimation has not been successfully performed, the traveling control unit 22 returns the process to step S50 shown in FIG. 7.

According to the fourth embodiment described above, the traveling control unit 22 executes a process at step S144 in which the a GNSS location is acquired at the timing after a reference time has elapsed, following the acquisition of the current GNSS location at step S140. The traveling control unit 22 sets the current GNSS location acquired at step S140 as the first vehicle location and sets the GNSS location acquired at step S144 as the second vehicle location. For each of the plurality of candidate locations, the traveling control unit 22 calculates the degree of similarity between a partial route connecting the first vehicle location and the second vehicle location, and a registration partial route connecting the candidate location corresponding to the first vehicle location and the location on the registered route RO corresponding to the second vehicle location. The traveling control unit 22 sets, as the initial location, the candidate location having the highest similarity among the plurality of candidate locations and attempts self-location estimation. When self-location estimation is performed using a registration point RP of which the degree of similarity between the partial route and the registration partial route is high, the probability of successfully estimating the self-location is high. Therefore, by attempting self-location estimation using candidate locations with high similarity among the plurality of candidate locations, the self-location can be estimated efficiently.

### Other Embodiments

In the assistance process of the first embodiment described above, after determined at step S56 that the distance between the closest vicinity location and the current location is shorter than or equal to the reference distance d4, the self-location estimation is performed. In another embodiment, self-location estimation may not be performed. For example, if the error between the actual vehicle location and both the GNSS location acquired during the registration process and the GNSS location acquired during the assistance process is sufficiently small, the closest vicinity location may be assumed to be the current vehicle location, and the traveling assistance control may be started.

In the fourth embodiment described above, the traveling control unit 22 sets, as an initial value for the self-location estimation, a candidate location of a registration partial route having the highest degree of similarity to a partial route connecting the first vehicle location and the second vehicle location and corresponding to the registration partial route. In another embodiment, instead of using two vehicle locations, namely the first vehicle location and the second vehicle location, a candidate location of the registration partial route having the highest degree of similarity to the partial route connecting three or more vehicle locations and corresponding to the registration partial route may be set as the initial value for the self-location estimation. In this embodiment, after acquiring a current location, the traveling control unit 22 acquires one or more GNSS locations by acquiring the GNSS location at a timing when a predetermined reference time has elapsed, one or more times. Specifically, after acquiring the n-th vehicle location and determining that the reference time has elapsed, the traveling control unit 22 repeatedly performs processing to store, into the memory 30, the current GNSS location acquired at that time as the (n+1)-th vehicle location, thereby acquiring three or more vehicle locations. Next, the traveling control unit 22 sets, as the initial value for the self-location estimation, a candidate location of a registration partial route having the highest degree of similarity to a partial route connecting the three or more vehicle locations in the order of acquisition and corresponding to the registration partial route. The partial route connecting three or more vehicle locations is a route represented by a polyline in which a plurality of line segments are connected in series. According to this configuration, the vehicle location can be estimated more efficiently.

In the fourth embodiment described above, the traveling control unit 22 sets, as an initial value for the self-location estimation, a candidate location of a registration partial route having the highest degree of similarity to a partial route connecting the first vehicle location and the second vehicle location and corresponding to the registration partial route. In another embodiment, as in the second embodiment, the traveling control unit 22 may perform the self-location estimation by preferentially setting, as initial locations for the self-location estimation, a plurality of candidate locations in descending order of the degree of similarity.

In the first embodiment described above, the target position RP4 is included in the parking area PA. However, the application of the present disclosure is not limited to a case where the target position RP4 is included in the parking area PA, that is, where the target position RP4 is a parking position. In the first embodiment described above, the passing points include two points, namely passing point RP2 and passing point RP3. However, the number of passing points may be one, or three or more. By including at least one passing point in the registration route RO, it is possible to enable the start of the traveling assistance even when the GNSS location is acquired with an error.

The present disclosure is not limited to the above-described embodiments and modification examples and various configurations may be utilized without departing from the spirit of the present disclosure. For example, embodiments corresponding to technical features in examples described in the summary section, technical features in the modification examples may be appropriately replaced or combined in order to solve a part or all of issues in the above-described problems to be solved, or in order to accomplish a part or all of the above-described effects and advantages. Further, unless the above-described technical features are described as necessary in the present specification, the technical features may be appropriately removed.

The registration unit 21 and the traveling control unit 22 thereof disclosed in the present disclosure may be accomplished by a dedicated computer constituted of a processor and a memory programmed to execute one or more functions embodied by computer programs. Alternatively, the registration unit 21 and the traveling control unit 22 thereof disclosed in the present disclosure may be accomplished by a dedicated computer provided by a processor configured of one or more dedicated hardware logic circuits. Further, the registration unit 21 and the traveling control unit 22 thereof disclosed in the present disclosure may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media.

### Aspects

Features of the present disclosure are described below.

### (Aspect 1)

A traveling assistance apparatus (100) comprising:
a registration unit (21) that generates registration information (31) as information related to a registration route (RO) from a start point to a destination point; and
a traveling control unit (22) that performs a traveling assistance control using the registration information to cause a vehicle to travel to the destination point when a start condition in which the vehicle approaches the registration route is satisfied,
   wherein
the registration unit utilizes a first sensor (SA) mounted on the vehicle for detecting a satellite positioning position based on a satellite positioning system, to detect the satellite positioning position, and causes the registration information to include information of satellite positioning positions corresponding to a plurality of registration points including the start point, the destination point and at least one passing point on the registration route; and
the traveling control unit determines that the start condition is satisfied, when at least a distance condition in which a distance between a current location as a current satellite positioning position and any one of the plurality of registration points is shorter than or equal to a reference distance is satisfied.

### (Aspect 2)

The traveling assistance apparatus according to aspect 1, wherein
the distance condition is a first condition;
the registration unit i) utilizes a second sensor (SB) mounted on the vehicle for detecting an object around the vehicle and a trajectory of the vehicle to detect a detection value from the second sensor, ii) associates object information as information of the object and trajectory information as information of the trajectory with positions on the registration route using the detection value, and iii) causes the registration information to include the object information and the trajectory information associated with the positions on the registration route;
the traveling control unit iv) utilizes the object information and the trajectory information associated with at least one of candidate locations as a registration point, among the plurality of registration points, of which the distance to the current location is shorter than or equal to the reference distance, and the detection value from the second sensor, to attempt a self-location estimation that estimates a relative location of the vehicle relative to the object, and v) determines that the start condition is satisfied when a second condition is satisfied in which the self-location estimation is succeeded and the first condition is satisfied.

### (Aspect 3)

The traveling assistance apparatus according to aspect 2, wherein
the traveling control unit acquires the closest vicinity location in which a distance to the current location is the shortest among the plurality of registration points, sets the closest vicinity location as at least one candidate location to be an initial location when a distance between the closest vicinity location and the current location is shorter than or equal to the reference distance, and attempts the self-location estimation.

### (Aspect 4)

The traveling assistance apparatus according to aspect 2, wherein
the traveling control unit sets, when only one candidate location is present among at least one of candidate locations, the one candidate location to be an initial location and attempts the self-location estimation; and
the traveling control unit preferentially sets, when a plurality of candidate locations are present among at least one of candidate locations, the plurality of candidate locations to be the initial location in ascending order of a distance to the current location, and attempts the self-location estimation.

### (Aspect 5)

The traveling assistance apparatus according to aspect 2, wherein
the registration unit acquires a satellite positioning direction indicating a traveling direction of the vehicle using the first sensor, associates information of the satellite positioning direction corresponding to each of the plurality of registration points with the satellite positioning position, and causes the registration information to include the information of the satellite positioning direction associated with the satellite positioning position;
the traveling control unit sets, when only one candidate location is present among at least one of candidate locations, the one candidate location to be an initial location and attempts the self-location estimation; and
the traveling control unit preferentially sets, when a plurality of candidate locations are present among at least one of candidate locations, the plurality of candidate locations to be the initial location in ascending order of an error between a current satellite positioning direction and a satellite positioning direction of the registration information, and attempts the self-location estimation.

### (Aspect 6)

The traveling assistance apparatus according to aspect 2, wherein
the traveling control unit sets, when only one candidate location is present among at least one of candidate locations, the one candidate location to be an initial location and attempts the self-location estimation;
when a plurality of candidate locations are present among at least one of candidate locations, the traveling control unit acquires, after acquiring a current location, one or more satellite positioning position by acquiring the satellite positioning position one or more times at a timing when a predetermined reference time has elapsed;
the traveling control unit utilizes, for each of the plurality of candidate locations, (a) a partial route connecting the current location and the one or more satellite positioning positions in the order of acquisition, and (b) a registered partial route connecting each candidate location corresponding to the current location and one or more locations on the registered route corresponding to the one or more satellite positioning positions, to calculate a degree of similarity; and
the traveling control unit sets, among the plurality of candidate locations, the candidate location having the highest degree of similarity to be the initial location, and attempts the self-location estimation.

The present disclosure may also be implemented in various manners other than a traveling assistance apparatus. For example, it may be implemented in the form of a traveling assistance method or the like.

### Conclusion

As described, the present disclosure may be embodied in the following manners.

According to a first aspect of the present disclosure, a traveling assistance apparatus is provided. The traveling assistance apparatus includes: a registration unit (21) that generates registration information (31) as information related to a registration route (RO) from a start point to a destination point; and a traveling control unit (22) that performs a traveling assistance control using the registration information to cause a vehicle to travel to the destination point when a start condition in which the vehicle approaches the registration route is satisfied. The registration unit utilizes a first sensor (SA) mounted on the vehicle for detecting a satellite positioning position based on a satellite positioning system, to detect the satellite positioning position, and causes the registration information to include information of satellite positioning positions corresponding to a plurality of registration points including the start point, the destination point and at least one passing point on the registration route; and the traveling control unit determines that the start condition is satisfied, when at least a distance condition in which a distance between a current location as a current satellite positioning position and any one of the plurality of registration points is shorter than or equal to a reference distance is satisfied.

According to the first aspect, the registration information includes a plurality of satellite positioning positions. Therefore, even when an error between the current satellite positioning position and the actual location of the vehicle is large, traveling assistance control can be performed if the distance between the current satellite positioning position and any one of the plurality of satellite positioning positions included in the registration information is equal to or less than a reference distance. It is thus possible to reduce situations in which traveling assistance control is not started despite the vehicle approaching the registered route.

What is claimed is:

1. A traveling assistance apparatus comprising:
a registration unit that generates registration information as information related to a registration route from a start point to a destination point; and
a traveling control unit that performs a traveling assistance control using the registration information to cause a vehicle to travel to the destination point when a start condition in which the vehicle approaches the registration route is satisfied,
wherein
the registration unit utilizes a first sensor mounted on the vehicle for detecting a satellite positioning position based on a satellite positioning system, to detect the satellite positioning position, and causes the registration information to include information of satellite positioning positions corresponding to a plurality of registration points including the start point, the destination point and at least one passing point on the registration route; and
the traveling control unit determines that the start condition is satisfied, when at least a distance condition in which a distance between a current location as a current satellite positioning position and any one of the plurality of registration points is shorter than or equal to a reference distance is satisfied.

2. The traveling assistance apparatus according to claim 1, wherein
the distance condition is a first condition;
the registration unit i) utilizes a second sensor mounted on the vehicle for detecting an object around the vehicle and a trajectory of the vehicle to detect a detection value from the second sensor, ii) associates object information as information of the object and trajectory information as information of the trajectory with positions on the registration route using the detection value, and iii) causes the registration information to include the object information and the trajectory information associated with the positions on the registration route; and
the traveling control unit iv) utilizes the object information and the trajectory information associated with at least one of candidate locations as a registration point, among the plurality of registration points, of which the distance to the current location is shorter than or equal to the reference distance, and the detection value from the second sensor, to attempt a self-location estimation that estimates a relative location of the vehicle relative to the object, and v) determines that the start condition is satisfied when a second condition is satisfied in which the self-location estimation is succeeded and the first condition is satisfied.

3. The traveling assistance apparatus according to claim 2, wherein
the traveling control unit acquires the closest vicinity location in which a distance to the current location is the shortest among the plurality of registration points, sets the closest vicinity location as at least one candidate location to be an initial location when a distance between the closest vicinity location and the current location is shorter than or equal to the reference distance, and attempts the self-location estimation.

4. The traveling assistance apparatus according to claim 2, wherein
the traveling control unit sets, when only one candidate location is present among at least one of candidate locations, the one candidate location to be an initial location and attempts the self-location estimation; and
the traveling control unit preferentially sets, when a plurality of candidate locations are present among at least one of candidate locations, the plurality of candidate locations to be the initial location in ascending order of a distance to the current location, and attempts the self-location estimation.

5. The traveling assistance apparatus according to claim 2, wherein
the registration unit acquires a satellite positioning direction indicating a traveling direction of the vehicle using the first sensor, associates information of the satellite positioning direction corresponding to each of the plurality of registration points with the satellite positioning position, and causes the registration information to include the information of the satellite positioning direction associated with the satellite positioning position;
the traveling control unit sets, when only one candidate location is present among at least one of candidate locations, the one candidate location to be an initial location and attempts the self-location estimation; and
the traveling control unit preferentially sets, when a plurality of candidate locations are present among at least one of candidate locations, the plurality of candidate locations to be the initial location in ascending order of an error between a current satellite positioning direction and a satellite positioning direction of the registration information, and attempts the self-location estimation.

6. The traveling assistance apparatus according to claim 2, wherein
the traveling control unit sets, when only one candidate location is present among at least one of candidate locations, the one candidate location to be an initial location and attempts the self-location estimation;
when a plurality of candidate locations are present among at least one of candidate locations, the traveling control unit acquires, after acquiring a current location, one or more satellite positioning position by acquiring the satellite positioning position one or more times at a timing when a predetermined reference time has elapsed;
the traveling control unit utilizes, for each of the plurality of candidate locations, (a) a partial route connecting the current location and the one or more satellite positioning positions in the order of acquisition, and (b) a registered partial route connecting each candidate location corresponding to the current location and one or more locations on the registered route corresponding to the one or more satellite positioning positions, to calculate a degree of similarity; and
the traveling control unit sets, among the plurality of candidate locations, the candidate location having the highest degree of similarity to be the initial location, and attempts the self-location estimation.

7. A traveling assistance apparatus comprising a processor programed to:
generate registration information as information related to a registration route from a start point to a destination point; and
perform a traveling assistance control using the registration information to cause a vehicle to travel to the destination point when a start condition in which the vehicle approaches the registration route is satisfied,
wherein
the processor is programed to utilize a first sensor mounted on the vehicle for detecting a satellite positioning position based on a satellite positioning system, to detect the satellite positioning position, and cause the registration information to include information of satellite positioning positions corresponding to a plurality of registration points including the start point, the destination point and at least one passing point on the registration route; and
the processor is programed to determine that the start condition is satisfied, when at least a distance condition in which a distance between a current location as a current satellite positioning position and any one of the plurality of registration points is shorter than or equal to a reference distance is satisfied.

8. The traveling assistance apparatus according to claim 7, wherein
the distance condition is a first condition;
the processor is programmed to i) utilize a second sensor mounted on the vehicle for detecting an object around the vehicle and a trajectory of the vehicle to detect a detection value from the second sensor, ii) associate object information as information of the object and trajectory information as information of the trajectory with positions on the registration route using the detection value, and iii) cause the registration information to include the object information and the trajectory information associated with the positions on the registration route; and
the processor is programmed to iv) utilize the object information and the trajectory information associated with at least one of candidate locations as a registration point, among the plurality of registration points, of which the distance to the current location is shorter than or equal to the reference distance, and the detection value from the second sensor, to attempt a self-location estimation that estimates a relative location of the vehicle relative to the object, and v) determine that the start condition is satisfied when a second condition is satisfied in which the self-location estimation is succeeded and the first condition is satisfied.

9. The traveling assistance apparatus according to claim 8, wherein
the processor is programmed to acquire the closest vicinity location in which a distance to the current location is the shortest among the plurality of registration points, set the closest vicinity location as at least one candidate location to be an initial location when a distance between the closest vicinity location and the current location is shorter than or equal to the reference distance, and attempt the self-location estimation.

10. The traveling assistance apparatus according to claim 8, wherein
the processor is programmed to set, when only one candidate location is present among at least one of candidate locations, the one candidate location to be an initial location and attempts the self-location estimation; and
the processor is programmed to preferentially set, when a plurality of candidate locations are present among at least one of candidate locations, the plurality of candidate locations to be the initial location in ascending order of a distance to the current location, and attempt the self-location estimation.

11. The traveling assistance apparatus according to claim 8, wherein
the processor is programmed to acquire a satellite positioning direction indicating a traveling direction of the vehicle using the first sensor, associate information of the satellite positioning direction corresponding to each of the plurality of registration points with the satellite positioning position, and cause the registration information to include the information of the satellite positioning direction associated with the satellite positioning position;
the processor is programmed to set, when only one candidate location is present among at least one of candidate locations, the one candidate location to be an initial location and attempts the self-location estimation; and
the processor is programmed to preferentially set, when a plurality of candidate locations are present among at least one of candidate locations, the plurality of candidate locations to be the initial location in ascending order of an error between a current satellite positioning direction and a satellite positioning direction of the registration information, and attempt the self-location estimation.

12. The traveling assistance apparatus according to claim 8, wherein
the processor is programmed to set, when only one candidate location is present among at least one of candidate locations, the one candidate location to be an initial location and attempt the self-location estimation;
the processor is programmed to acquire, when a plurality of candidate locations are present among at least one of candidate locations, after acquiring a current location, one or more satellite positioning position by acquiring the satellite positioning position one or more times at a timing when a predetermined reference time has elapsed;
the processor is programmed to utilize, for each of the plurality of candidate locations, (a) a partial route connecting the current location and the one or more satellite positioning positions in the order of acquisition, and (b) a registered partial route connecting each candidate location corresponding to the current location and one or more locations on the registered route corresponding to the one or more satellite positioning positions, to calculate a degree of similarity; and
the processor is programmed to set, among the plurality of candidate locations, the candidate location having the highest degree of similarity to be the initial location, and attempt the self-location estimation.

13. A method for traveling assistance of a vehicle comprising steps of:
generating registration information as information related to a registration route from a start point to a destination point;
performing a traveling assistance control using the registration information to cause the vehicle to travel to the destination point when a start condition in which the vehicle approaches the registration route is satisfied;
utilizing a first sensor mounted on the vehicle for detecting a satellite positioning position based on a satellite positioning system, to detect the satellite positioning position;
causing the registration information to include information of satellite positioning positions corresponding to a plurality of registration points including the start point, the destination point and at least one passing point on the registration route; and
determining that the start condition is satisfied, when at least a distance condition in which a distance between a current location as a current satellite positioning position and any one of the plurality of registration points is shorter than or equal to a reference distance is satisfied.
